(19) United States
(12) Patent Application Publication
(10) Pub. No.: US 2010/0066869 A1
(43) Pub. Date: Mar. 18, 2010

(54) VIDEO SIGNAL PROCESSING APPARATUS, IMAGE PICKUP APPARATUS, DISPLAY APPARATUS, AND VIDEO SIGNAL PROCESSING METHOD

(76) Inventor: Yasutaka Nakashima, Kanagawa (JP)

Correspondence Address: FROMMER LAWRENCE & HAUG LLP, 745 FIFTH AVENUE, NEW YORK, NY, 10151, US

(21) Appl. No.: 12/561,315

(22) Filed: Sep. 17, 2009

(30) Foreign Application Priority Data
Sep. 18, 2008 (JP) P2008-239904

(51) Int. Cl. H04N 5/217

(52) U.S. Cl. 348/241; 348/607; 348/E05.079; 348/E05.078

(57) ABSTRACT

A video signal processing apparatus includes: a level detection unit configured to detect a level of a high-frequency component extracted from an input video signal to determine whether or not the detected level is in excess of a preset predetermined threshold value; and a signal output unit configured to output, as a color video signal, an input video signal in a section in which the level of the high-frequency component has been determined by the level detection unit to be in excess of the predetermined threshold value and, as a monochromatic video signal, an input video signal in a section in which the level of the high-frequency component has been determined to be lower than the predetermined threshold value.

### BACKGROUND OF THE INVENTION

1. Field of the Invention

The present invention relates to a video signal processing apparatus, an image pickup apparatus, a display apparatus, and a video signal processing method and, more particularly, to a technology for displaying contour parts of an image in an enhanced manner.

2. Description of the Related Art

With video cameras and image pickup apparatuses for broadcasting stations and profession uses, in order to increase the degree of freedom in the video expression concerned, a manual focus function which can reflect the intention of a producer (or a user) is more often used than an automatic focus function which automatically performs focusing.

With such video cameras, in order to facilitate manual focus adjustment, the high-frequency component of each video signal is enhanced at the time of focus adjustment and a resultant video signal is displayed on the viewfinder or the display apparatus of each video camera. To be more specific, a high-frequency component is extracted from the luminance signal constituting each video signal is extracted to generated an edge enhancement signal, which is added to the luminance signal of a line video signal, thereby outputting a resultant signal to the viewfinder or the display apparatus.

As a subject of imaging is brought to focus by an focus adjusting operation, the amount of the high-frequency component of a luminance signal increases, so that, by performing the processes described above, the edge portion of an image on the screen is enhanced. Consequently, the user can adjust focus while checking on the screen whether or not the focus has been obtained.

At this moment, in order to more clearly display the edge-enhanced portion on the screen, it is also practiced to give a particular color to the edge-enhanced portion. For example, Japanese Patent Laid-open No. 2002-196225 (hereinafter referred to as Patent Document 1) discloses a technology for giving a particular color to an area in focus and displaying the colored area.

### SUMMARY OF THE INVENTION

In giving a particular color to the edge portion of an image as described in Patent Document 1 above, if a high-frequency component is included in a taken image, the entire screen is colored. If this happens, the picture unexpectedly becomes less identifiable. Also, in this case, giving a particular color to the edge-enhanced portion causes a problem that the user cannot recognize the inherent color of a subject of imaging.

In the case where no particular color is given, the related-art technology in which an edge-enhanced signal is added to the luminance signal of a line video signal changes the levels of the luminance signal. This causes problems that the edge portions of an image are expressed as being glaring, for example, making the original picture look other ways.

Further, in this case, if a taken image contains many noises, these noises are further enhanced by the above-mentioned edge enhancement processing. If the degree of edge enhancement is raised for making focusing easier in this state, pictures displayed on the screen are all affected by noises.

Therefore, the present invention addresses the above-identified and other problems associated with related-art methods and apparatuses and solves the addressed problems by providing a video signal processing apparatus, an image pickup apparatus, a display apparatus, and a video signal processing method that are configured to execute edge-enhanced display without damaging the color inherent to a subject of imaging in a area in focus.

In carrying out the invention and according to one embodiment thereof, there is provided a video signal processing apparatus including a level detection unit configured to detect a level of a high-frequency component extracted from an input video signal to determine whether or not the detected level is in excess of a preset predetermined threshold value. The video signal processing apparatus further includes a signal output unit configured to output, as a color video signal, an input video signal in a section in which the level of the high-frequency component has been determined by the level detection unit to be in excess of the predetermined threshold value and, as a monochromatic video signal, an input video signal in a section in which the level of the high-frequency component has been determined to be lower than the predetermined threshold value.

Consequently, if the level of the signal extracted from the input video signal is found to be in excess of the predetermined threshold value, namely, if a photographic subject is in focus, an area in which the level is in excess of the predetermined threshold value is displayed in color and the other areas are displayed monochromatically.

The above-mentioned novel configuration prevents an image displayed on a screen from being hard to see if a picked up image contains many high-frequency component.

According to another embodiment of the present invention, there is provided an image pickup apparatus including: an image pickup unit configured to photoelectrically convert a subject light into a video signal; and a level detection unit configured to detect a level of a high-frequency component extracted from the video signal generated by the image pickup unit to determine whether or not the detected level is in excess of a preset predetermined threshold value. The image pickup apparatus further includes a signal output unit configured to output, as a color video signal, an input video signal in a section in which the level of the high-frequency component is determined by the level detection unit to be in excess of the predetermined threshold value and, as a monochromatic signal, an input video signal in a section in which the level of the high-frequency component is determined to be lower than the predetermined threshold value.

According to a further embodiment of the present invention, there is provided a display apparatus including: a level detection unit configured to detect a level of a high-frequency component extracted from an input video signal to determine whether or not the detected level is in excess of a preset predetermined threshold value; and a signal output unit configured to output, as a color video signal, an input video signal in a section in which the level of the high-frequency component is determined by the level detection unit to be in excess of the predetermined threshold value and, as a monochromatic signal, an input video signal in a section in which the level of the high-frequency component is determined to be lower than the predetermined threshold value. The display apparatus further includes a display unit configured to display the video signal outputted from the signal output unit.

According to a still further embodiment of the present invention, there is provided a video signal processing method including the steps of: detecting a level of a high-frequency component extracted from an input video signal to determine whether or not the detected level is in excess of a preset predetermined threshold value; and outputting, as a color video signal, an input video signal in a section in which the level of the high-frequency component has been determined in the level detection step to be in excess of the predetermined threshold value and, as a monochromatic video signal, an input video signal in a section in which the level of the high-frequency component has been determined to be lower than the predetermined threshold value.

As described and according to the present invention, a portion containing a high-frequency component is displayed in color, while other portions are displayed monochromatically, so that a portion of a photographic subject in focus can be recognized with the color inherent to the photographic subject.

### BRIEF DESCRIPTION OF THE DRAWINGS

FIG. 1 is a block diagram illustrating an exemplary internal configuration of an image pickup apparatus practiced as one embodiment of the present invention;

FIG. 2 is a block diagram illustrating an exemplary internal configuration of a display signal processing unit practiced as one embodiment of the present invention;

FIG. 3 is a graph indicative of an exemplary configuration of a filter practiced as one embodiment of the present invention;

FIG. 4 is a diagram for describing an exemplary image formed by a video signal before passing the filter shown in FIG. 3;

FIG. 5 is a diagram for describing an exemplary image formed by a video signal after passing the filter shown in FIG. 3;

FIG. 6 is a graph indicative of an exemplary configuration of a filter practiced as one embodiment of the present invention;

FIG. 7 is a diagram for describing an exemplary image formed by a video signal after undergoing edge-enhancement processing practiced as one embodiment of the present invention;

FIG. 8 is a block diagram illustrating an exemplary internal configuration of a display signal processing unit practiced as another first embodiment of the present invention;

FIG. 9 is a block diagram illustrating an exemplary internal configuration of a display signal processing unit practiced as another second embodiment of the present invention;

FIG. 10 is a block diagram illustrating an exemplary internal configuration of a display signal processing unit practiced as another third embodiment of the present invention;

FIG. 11 is a block diagram illustrating an exemplary internal configuration of a display signal processing unit practiced as another fourth embodiment of the present invention;

FIG. 12 is a block diagram illustrating an exemplary internal configuration of the display signal processing unit shown in FIG. 11;

FIG. 13 is a block diagram illustrating an exemplary internal configuration of the display signal processing unit shown in FIG. 11;

FIG. 14 is a block diagram illustrating an exemplary internal configuration of the display signal processing unit shown in FIG. 11;

FIG. 15 is a block diagram illustrating an exemplary internal configuration of an image pickup apparatus practiced as another fifth embodiment of the present invention; and

FIG. 16 is a block diagram illustrating an exemplary internal configuration of the image pickup apparatus shown in FIG. 15.

### DETAILED DESCRIPTION OF THE PREFERRED EMBODIMENTS

The present invention will be described in further detail by way of embodiments thereof with reference to the accompanying drawings. It should be noted that the description will be made in the following order.

1. First embodiment (an example in which, in accordance with the level of a high-frequency component included in a color video signal, switching is made between monochromatized video signal and color video signal for output).

2. Variation 1 (an example in which a high-frequency component is extracted from a monochromatized signal).

3. Variation 2 (an example in which, in accordance with the level of a high-frequency component, the levels of line video signal are also changed).

4. Variation 3 (an example in which a luminance signal and a chrominance signal are separately transmitted).

5. Variation 4 (an example in which the edge enhancement by the related-art peaking technology and the edge-enhancement processing according to the present invention are used together).

6. Variation 5 (an example in which the present invention is applied to other apparatuses such as display apparatuses).

### 1. First Embodiment

### An Exemplary Internal Configuration of an Image Pickup Apparatus

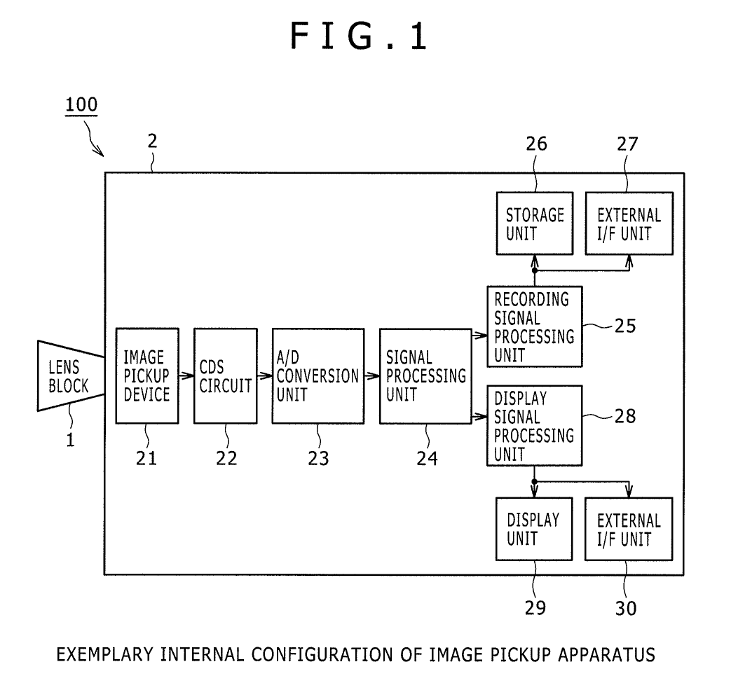

Now, referring to FIG. 1, there is shown an exemplary internal configuration of an image pickup apparatus practiced as a first embodiment of the present invention. An image pickup apparatus 100 shown in FIG. 1 has a lens block 1 for capturing a subject light into the image pickup apparatus 100 and a camera block 2. The lens block 1 includes a lens, a focus ring for adjusting lens position (the lens and the focus ring not shown), and so on.

The camera block 2 has an image pickup device 21 for photoelectrically converting a subject light entered through the lens of the lens block 1 to generate a video signal. The video signal generated by the image pickup device 21 is supplied to a correlated double sampling circuit (hereafter referred to as a CDS circuit) 22. The CDS circuit 22 removes a reset noise contained in the video signal generated by the image pickup device 21 and supplies a resultant video signal to an analog/digital conversion unit (hereafter referred to as an A/D conversion unit) 23.

The A/D conversion unit 23 converts a video signal supplied from the CDS circuit 22 into a digital signal and supplies this digital signal to a signal processing unit 24. The signal processing unit 24 executes feedback clamp processing for fixing the black level to a certain reference value and gamma correction processing on the supplied video signal and supplies a resultant video signal to a recording signal processing unit 25 and a display signal processing unit 28.

By use of an MPEG (Moving Picture Experts Group) data compression algorithm or the like, the recording signal processing unit 25 compresses the video signal processed by the signal processing unit 24 and supplies the compressed video signal to a storage unit 26 or an external interface unit 27. The storage unit 26, based on a HDD (Hard Disk Drive) or the like, stores video signals compressed by the recording signal processing unit 25, and the like. It should be noted that the video signals stored in the storage unit 26 are not restricted to those compressed; namely, uncompressed video signals may be stored in the storage unit 26.

By use of the NTSC (National Television System Committee) scheme or the like, the display signal processing unit 28 encodes the video signal processed by the signal processing unit 24 and executes processing such as converting the encoded video signal into an analog signal, thereby supplying the analog signal to a display unit 29 and an external interface unit 30. It should be noted that, a configuration may be provided in which not only the NTSC scheme but also the PAL (Phase Alternation by Line) scheme may be used. Further, a configuration may be provided in which not only a standard video signal but also an HD (High Definition) signal may be supplied. Also, the display signal processing unit 28 executes the processing of edge enhancement for displaying an in-focus area in color. This processing will be detailed later.

The display unit 29 is a viewfinder based on LCD (Liquid Crystal Display) or the like, which displays the video signal processed by the display signal processing unit 28 as an image. In the present embodiment, it is assumed that the display unit 29 be incorporated in the image pickup apparatus 100.

### [Exemplary Internal Configuration of the Display Signal Processing Unit]

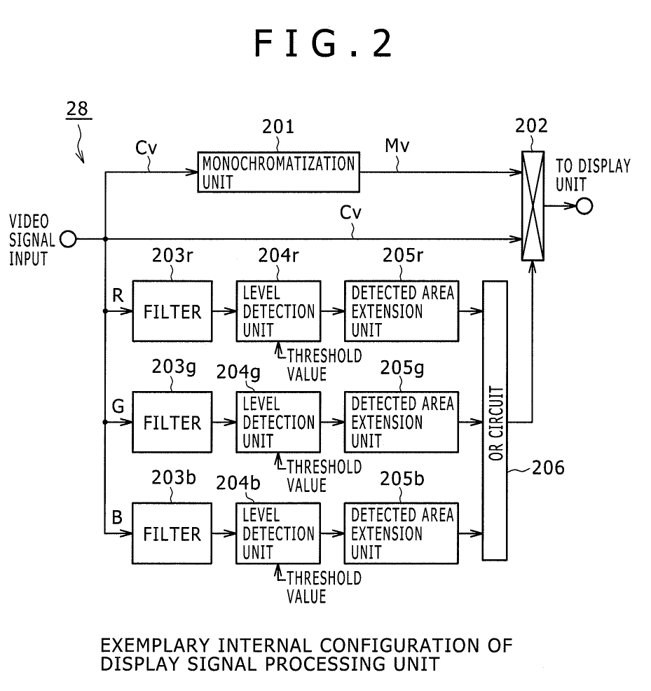

The following describes an exemplary configuration of a edge-enhancement processing portion of the display signal processing unit 28 with reference to FIG. 2. In the configuration shown in FIG. 2, the video signal to be outputted from the signal processing unit 24 is an RGB signal. It should be noted that, in this case, an RGB signal is processed; however, the similar processing may be executed on an XYZ signal.

RGB signal Cv entered from the signal processing unit 24 (refer to FIG. 1) is supplied to a monochromatization unit 201, a selector 202, a filter 203r, a filter 203g, and a filter 203b. The monochromatization unit 201 converts RGB signal Cv into monochromatic video signal Mv and outputs the monochromatic video signal Mv to the selector 202. The selector 202 selects one of the monochromatic video signal Mv outputted from the monochromatization unit 201 and RGB signal Cv supplied from the signal processing unit 24 and outputs the selected signal to the display unit 29.

The filter 203r, the filter 203g, and the filter 203b are each made up of a high-pass filter or the like. In the filter 203r, an R signal is entered. In the filter 203g, a G signal is entered. In the filter 203b, a B signal is entered. The filter 203r, the filter 203g, and the filter 203b extract the high-frequency component of each entered video signal to generate high-frequency signals and output the generated high-frequency signals to a level detection unit 204r, a level detection unit 204g, and a level detection unit 204b.

It should be noted that, in what follows, the filter 203r, the filter 203g, and the filter 203b are generically referred to as a filter 203 unless otherwise specified and the level detection unit 204r, the level detection unit 204g, and the level detection unit 204b are generically referred to as a level detection unit 204 unless otherwise specified.

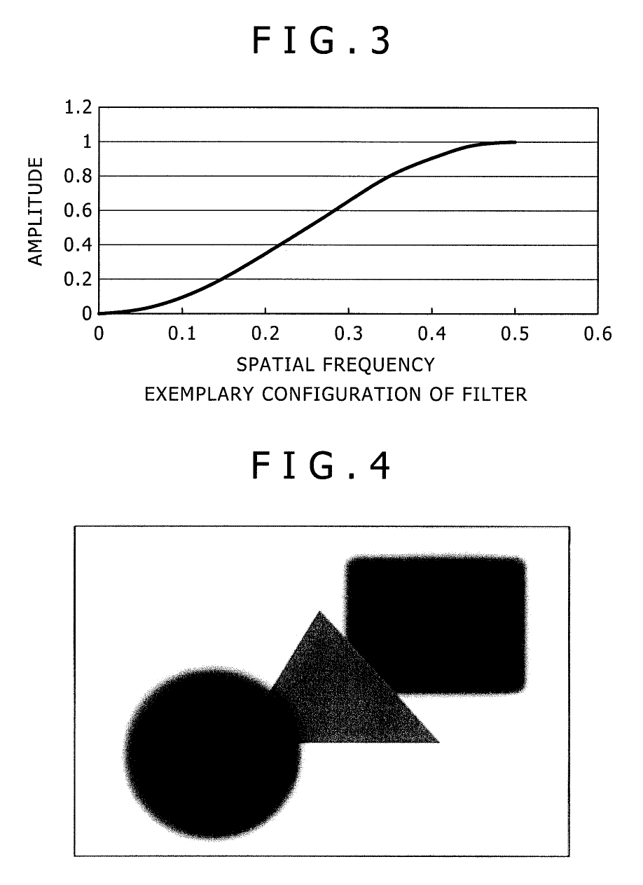

FIG. 3 shows an exemplary configuration of the filter 203. The vertical axis of graph shown in FIG. 3 is indicative of the amplitude of a video signal and the horizontal axis is indicative of spatial frequency (Fs). The filter characteristic shown in FIG. 3 was obtained when three steps (−1, 2, −1) of filter coefficients were used, indicating that this filter is designed so that, if the space frequency is low, the signal is attenuated and, if the spatial frequency is 0.5 Fs, the amplitude becomes the maximum.

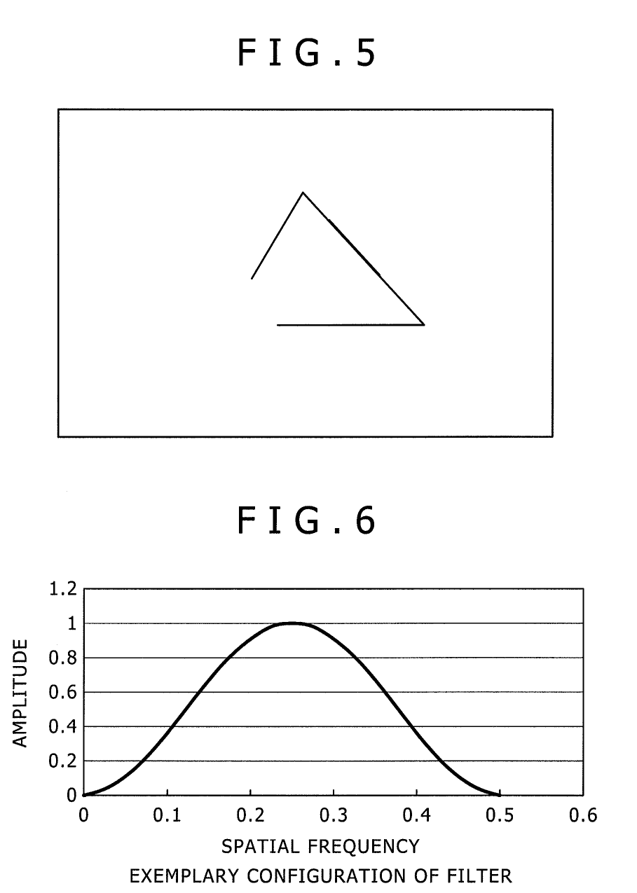

FIG. 4 shows an image obtained by RGB signal Cv before passing the filter 203, in which a subject having a circular shape, a subject having a triangular shape, and a subject having a rectangular shape are arranged from the foreground to the background. FIG. 4 shows a state in which the triangular subject is in focus and the circular and rectangular subjects are out of focus. FIG. 5 shows an image obtained by the high-frequency signal after passing the filter 203. Passing RGB signal Cv through the filter 203 allows the extraction of only the high-frequency component included in the edge portion of the triangular subject.

It should be noted that, in the above-mentioned example, the high-frequency component is extracted by configuring the filter 203 with a high-pass filter; however, it is also practicable to extract the high-frequency component by use of another filter, such as a differential filter, for example.

Also, a desired band may be passed through the filter 203 by a combination use of two or more filters. For example, in addition to the high-pass filter shown in FIG. 3, a band-pass filter as shown in FIG. 6 may be used. The filter shown in FIG. 6 has five steps (−1, 0, 2, 0, −1) for filter coefficients, indicating that this filter is designed so that, if the space frequency is low or high, the signal is attenuated and, if the spatial frequency is around 0.25 Fs, the amplitude becomes the maximum.

Referring to FIG. 2 again, the level detection unit 204r, the level detection unit 204g, and the level detection unit 204b each compares a preset threshold value with the level of the high-frequency signal outputted from the filter 203. Then, these level detection unit generate detection signals indicative whether or not the level of the high-frequency signal is in excess of the threshold value and outputs the generated detection signals to a detected area extension unit 205r, a detected area extension unit 205g, and a detected area extension unit 205b.

The detected area extension unit 205r, the detected area extension unit 205g, and the detected area extension unit 205b are each made up of a monostable multivibrator or the like. If the detection signal is indicative that the level of the high-frequency signal is in excess of the threshold value, that detection signal is held in the edge direction for the predetermined number of clocks, the peak-held detection signal being supplied to an OR circuit 206. The number of peak-hold clocks is determined by the user by specifying the width and so on of the extension area. It should be noted that, in what follows, the detected area extension unit 205r, the detected area extension unit 205g, and the detected area extension unit 205b are generically referred to as a detected area extension unit 205 unless otherwise specified.

If a detection signal indicative that the level of the high-frequency signal is in excess of the threshold value is entered from any one of the detected area extension unit 205r, the detected area extension unit 205g, and the detected area extension unit 205b, the OR circuit 206 outputs the detection signal to the selector 202.

If the detection signal from the OR circuit 206 is indicative that the level of the high-frequency signal is lower than the threshold value, the selector 202 outputs the monochromatic video signal Mv generated by the monochromatization unit 201. If the detection signal is indicative that the level of the high-frequency signal is in excess of the threshold value, the selector 202 selects and outputs RGB signal Cv while the detection signal is supplied. In the detected area extension unit 205, if the width of peak hold is set wide, the width (pulse width) of the detection signal in the time direction becomes wide, so that the time in which RGB signal Cv is selected and outputted by the selector 202 becomes long. Consequently, at a position where many high-frequency components are included, such as an image edge portion, not only the edge portion but also areas therearound are displayed in color. It should be noted that, in the present example, the detected area extension unit 205 is configured to output a detection signal regardless whether or not the level of the high-frequency signal is in excess of the threshold value; it is also practicable that the detected area extension unit 205 does not output a detection signal if the level of the high-frequency signal is lower than the threshold value.

### [Exemplary Operation of the Display Signal Processing Unit]

After the processing by each of the above-mentioned processing units, if the signal level of RGB signal Cv entered in the filter 203 is relatively high, a high-frequency signal is generated by the filter 203 to be outputted to the level detection unit 204. Then, if the level of the high-frequency signal is in excess of the threshold value, the level detection unit 204 outputs a detection signal indicative that the level of the high-frequency signal is in excess of the threshold value.

The detection signal generated by the level detection unit 204 is supplied to the detected area extension unit 205, the pulse width of the supplied detection signal is converted by the detected area extension unit 205 into a specified width, and the converted detection signal is supplied to the OR circuit 206. Thereafter, the detection signal supplied to the OR circuit 206 is output to the selector 202.

When the detection signal indicative that the level of the high-frequency signal is in excess of a predetermined threshold value is supplied, the selector 202 selects RGB signal Cv while the signal is entered, or in a period of time equivalent to the pulse width of the detection signal. If the detection signal is not entered, monochromatic video signal Mv is selected. Consequently, on the screen of the display unit 29 (refer to FIG. 1) to which these video signals are outputted, the edge portion of an image including the high-frequency component is displayed in color, the other portions being displayed monochromatically.

FIG. 7 shows a display example of an image generated on the basis of the video signal processed by the display signal processing unit 28. In FIG. 7, the image is monochromatically represented; actually, however, the edge portion of the image of the triangular subject in focus and the areas therearound are colored, the other portions being displayed monochromatically.

### EFFECTS OF THE PRESENT EMBODIMENT

According to the above-mentioned embodiment, an area in which many high-frequency components are contained, namely an area in focus, is displayed in the color inherent to the subject and the other areas out of focus are displayed monochromatically. Consequently, as the subject is brought to focus by a focus adjusting operation, the edge portion of the subject so far displayed monochromatically is displayed in color, so that the user can easily recognize the state of focusing.

In the above-mentioned case, the edge portion is not displayed in a particular color, such as yellow or white, as with related-art technologies, so that, even if two or more subject on the screen are in focus at the same time due to a large field depth, the picture displayed on the screen becomes not difficult to see.

Also, unlike related-art technologies, the processing of raising the level of luminance is not executed, so that the level of luminance inherent to the subject can be recognized in the edge-enhanced displayed image.

Further, if an enhancer is used for edge enhancement as with related-art technologies and the original video signal contain many noises, the noises themselves are also enhanced. In contrast, the present embodiment displays only the color inherent to the subject at the position with high-frequency components extracted, so that no noise enhancement occurs. In addition, if the level of detecting high frequency components is raised in order to strengthen the degree of edge enhanced display, no noise increase occurs. Consequently, focus adjustment can be easily done with a subject having no large luminance difference, such as the human skins, which is difficult to focus with related-art technologies. For example, an operation for focusing only the tip of the nose of a human face can be realized without involving noise increase.

It should be noted that, in the above-mentioned embodiment, the filter 203 is configured by a high-pass filter and, if a high-frequency component is extracted by the filter 203, RGB signal Cv is outputted from the selector 202; however, the configuration is not limited thereto. For example, the filter 203 may be configured by a lowpass filter and, if a low-frequency component (a component without high frequencies) is extracted, monochromatic video signal Mv may be outputted from the selector 202.

In addition, the above-mentioned embodiment is configured including the monochromatization unit 201 for monochromatizing RGB signal Cv; however, it is also practicable to have a configuration with the monochromatization unit 201. To be more specific, a multiplier for multiplying RGB signal Cv of the video line with each of edge-enhanced signals may be arranged to output therefrom an out-of-focus portion monochromatically and an in-focus portion in color.

Further, in the above-mentioned embodiment, peak hold processing is executed by the detected area extension unit 205 to expand the area on which edge enhancement by color display is performed; however, the configuration is not limited thereto. For example, a configuration is also possible in which the edge-enhanced area is expanded by giving hysteresis to the characteristic of the detected area extension unit 205 with the threshold value to be set to the level detection unit 204 set to a lower value.

### 2. Variation 1

It should be noted that, in the above-mentioned embodiment, the high-frequency component of RGB signal Cv is extracted to generate a high-frequency signal; it is also practicable to extract a high-frequency component from monochromatic signal Mv monochromatized by the monochromatization unit 201.

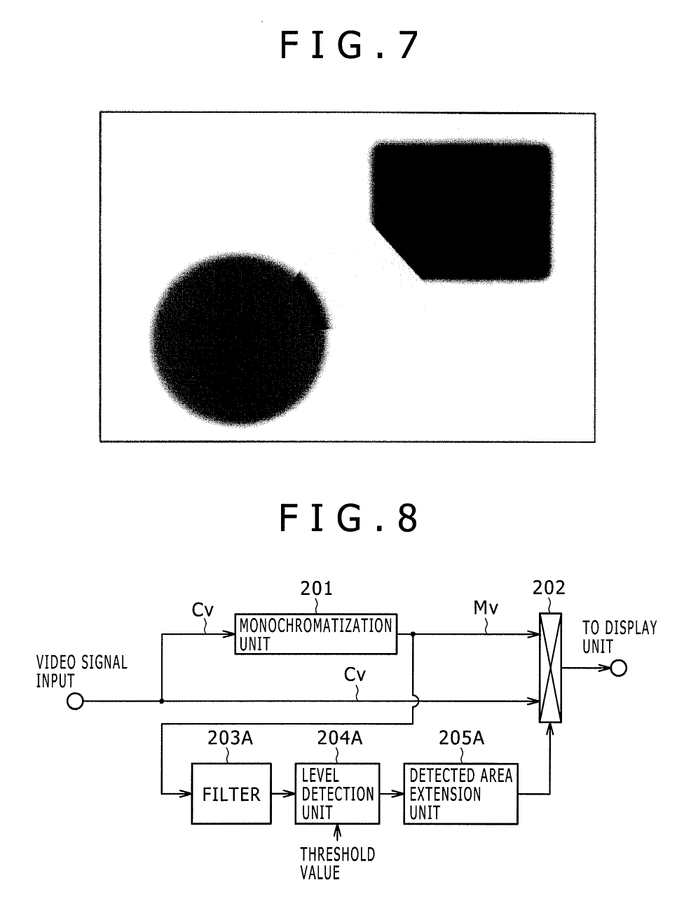

An exemplary configuration of the display signal processing unit 28 in the above-mentioned case is shown in FIG. 8. In FIG. 8, components similar to those previously described with reference to FIG. 2 are denoted by the same reference numerals and detail description there is skipped. In the display signal processing unit 28 shown in FIG. 8, monochromatic video signal Mv outputted from a monochromatization unit 201 is entered in a filter 203A. The filter 203A is assumed to be configured by a high-pass filter as with the filter shown in FIG. 3.

A high-frequency component extracted by the filter 203A is supplied to a level detection unit 204A as a high-frequency signal to be determined whether or not the level of the high-frequency signal is in excess of a preset threshold value. If the level of the high-frequency signal is in excess of the threshold value, peak hold processing is executed on the high-frequency signal by a detected area extension unit 205A in the following stage, the peak-held detection signal being supplied to a selector 202. In the selector 202, RGB signal Cv is selected while the detection signal is supplied from the detected area extension unit 205A to be outputted to a display unit 29 (refer to FIG. 1).

The above-mentioned configuration eliminates the necessity of preparing the filter 203A, the level detection unit 204A, and the detected area extension unit 205A for the number of R, G, and B signals. Therefore, this configuration can reduce the scale of the circuitry.

### 3. Variation 2

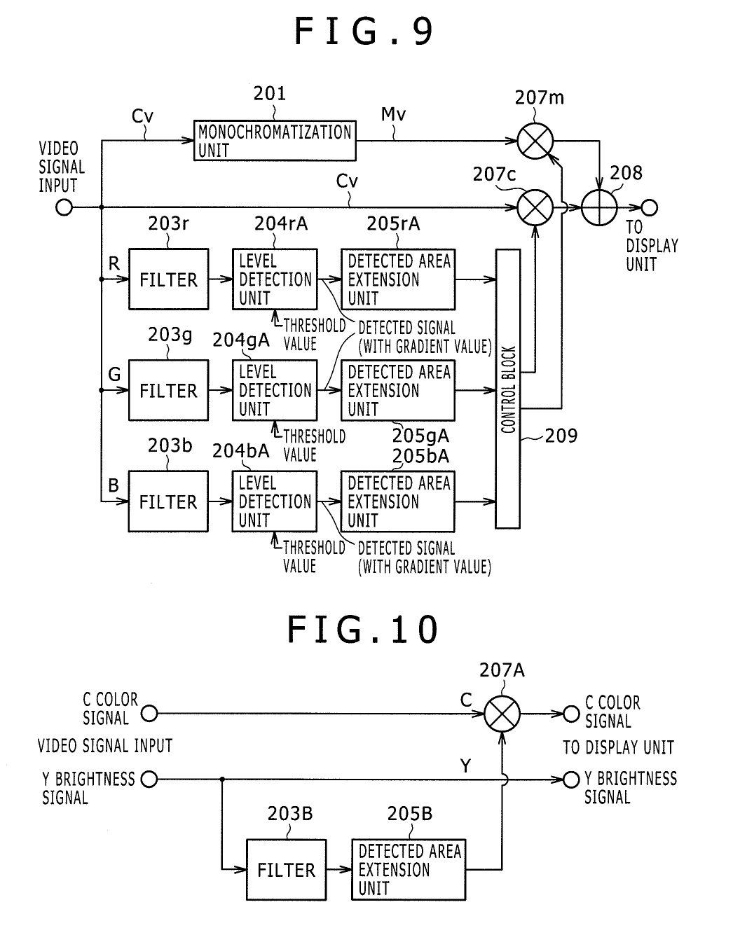

The following describes an exemplary configuration in which the display signal processing unit 28 is adjustable in the magnitude in the level direction of a detection signal, with reference to FIG. 9. In FIG. 9, components similar to those previously described with FIG. 2 and FIG. 8 are denoted by the same reference numerals and detail description thereof is skipped.

A display signal processing unit 28 shown in FIG. 9 has a multiplier 207c for multiplying RGB signal Cv with a control signal outputted from a control unit 209 and a multiplier 207m for multiplying monochromatic signal Mv with a control signal outputted from the control unit 209. In addition, the display signal processing unit 28 has an adder 208 for adding a signal outputted from the multiplier 207m to a signal outputted from the multiplier 207c.

A level detection unit 204rA, a level detection unit 204gA, and a level detection unit 204bA shown in FIG. 9 do not determine whether or not the level if an entered high-frequency signal is in excess of a threshold value, but output a detection signal with the level of a high-frequency signal indicated in a gradient value.

A detected area extension unit 205rA, a detected area extension unit 205gA, and a detected area extension unit 205bA execute the above-mentioned peak hold processing if the level of the detection signal is in excess of the threshold value and output the processed detection signal to the control unit 209.

If the level of the high-frequency signal indicated in the entered detection signal is in excess of the threshold value, the control unit 209 generates a control signal for setting the gain of the multiplier 207c to a predetermined value and setting the gain of the multiplier 207m to 0. If the level of the high-frequency signal is below the threshold value, the controller 209 generates a control signal for setting the gain of the multiplier 207m to a predetermined value and setting the gain of the multiplier 207c to 0. Then, the control unit 209 supplies the detection signal entered from any one of the detected area extension unit 205rA, the detected area extension unit 205gA, and the detected area extension unit 205bA and the generated control signal to both the multiplier 207m and the multiplier 207c. Next, the signal outputted from the multiplier 207m and the signal outputted from the multiplier 207c are added in the adder 208 to be outputted to the display unit.

Configuring the display signal processing unit 28 as described above sets the gain of the multiplier 207m to 0 if the level of the high-frequency signal is in excess of the threshold value, thereby outputting signals only from the multiplier 207c. If the level of the high-frequency signal is below the threshold value, the gain of the multiplier 207c is set to 0, so that signals are outputted only from the multiplier 207m. Namely, in the edge portion of an image containing many high-frequency components, the RGB signal outputted through the multiplier 207c is outputted to the display unit 29; in other areas, monochromatic signal Mv outputted through the multiplier 207m is outputted to the display unit 29.

At this moment, RGB signal Cv outputted through the multiplier 207c is one obtained by multiplying by a detection signal having the information of a gradient value of the high-frequency signal. Therefore, if the level of the high-frequency signal detected by the filter 203 is high, the color of the edge portion of the image is displayed on the display unit 29 in a dark tone.

Consequently, the user can easily determine the degree of focusing by the dark and light of coloring that appear in the edge portion of each image.

### 4. Variation 3

The following describes an exemplary configuration of a display signal processing unit 28 in the case where luminance signal Y and chrominance signal C are separately transmitted from the signal processing unit 24 (refer to FIG. 1), with reference to the block diagram shown in FIG. 10. In FIG. 10, components similar to those previously described with reference to FIG. 2 and FIG. 9 are denoted by the same reference numerals and details description thereof is skipped.

The display signal processing unit 28 shown in FIG. 10 has a filter 203B for extracting the high-frequency component of luminance signal Y, a level detection unit 204B, a detected area extension unit 205B, and a multiplier 207A.

The level detection unit 204B outputs a detection signal with the level of the high-frequency signal extracted by the filter 203B indicated by gradient value. In addition, if the level of the high-frequency signal is below a preset threshold value, the level detection unit 204B controls the multiplier 207A to set the gain to 0; if the level of the high-frequency signal is in excess of the threshold value, the level detection unit 204B also outputs a control signal to set the gain of the multiplier 207A to a predetermined value.

The detected area extension unit 205B executes the same expansion processing as the above-mentioned detected area extension unit 205 to output the processed detection signal and the control signal supplied from the level detection unit 204B to the multiplier 207A.

Configuring the display signal processing unit 28 as described above detects the high-frequency component through the filter 203B and, if the level of the detected high-frequency component is in excess of a predetermined threshold value, supplies a detection signal processed by the detected area extension unit 205B and a control signal to the multiplier 207A. Namely, the edge portion of an image and areas therearound are displayed in color and the display color is represented in a density corresponding to the degree at which high-frequency components are contained.

If no high-frequency component is detected through the filter 203B, then chrominance signal C of the video line is multiplied by no signal, so that an ordinary monochromatic image is displayed on the screen of the display unit 29.

### 5. Variation 4

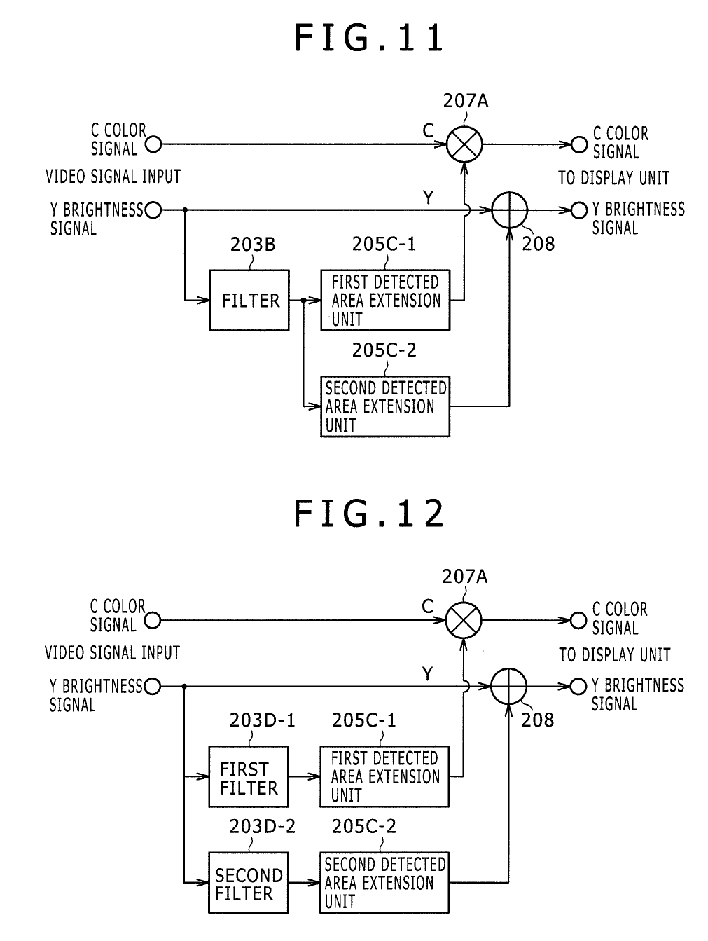

The following describes a configuration in which both the related-art edge enhancement processing called peaking and the edge enhancement processing according to the present embodiment can be used, with reference to FIG. 11 through FIG. 14. The peaking denotes a technique in which an edge-enhanced signal generated by extracting the high-frequency component of a luminance signal is added to a luminance signal of the video line to enhance the edge portion of an image for display. It should be noted that, with reference to FIG. 11 through FIG. 14, components similar to those previously described with reference to FIG. 2, FIG. 8, FIG. 9, and FIG. 10 are denoted by the same reference numerals and detail description thereof is skipped.

With a display signal processing unit 28 shown in FIG. 11, a first detected area extension unit 205C-1 and a second detected area extension unit 205C-2 are arranged after a filter 203B. In this configuration, a detection signal processed by the first detected area extension unit 205C-1 is multiplied by chrominance signal C of the video line through a multiplier 207A and a detection signal processed by the second detected area extension unit 205C-2 is added to luminance signal Y of the video line through an adder 208.

The configuration mentioned above allows the use of both the related-art edge enhancement based on the peaking in which the detection signal processed by the second detected area extension unit 205C-2 is added to luminance signal of the video line and the edge enhancement in which the detection signal is added to chrominance signal C. It should be noted that, in this configuration, the user can select between the edge enhancement based on the peaking and the edge enhancement based on the color inherent to the subject.

In a display signal processing unit 28 shown in FIG. 12, a filter (a first filter 203D-1) for a first detected area extension unit 205C-1 and a filter (a second filter 203D-2) for a second detected area extension unit 205C-2 are configured separately. In this configuration, a detection signal processed by the detected area extension unit 205C-1 is multiplied by chrominance signal C of the video line through a multiplier 207A and a detection signal processed by the second detected area extension unit 205C-2 is added to luminance signal Y of the video line through an adder 208.

As described above, separately arranging the filter for the related-art peaking processing and the filter for enhanced display based on the color inherent to each subject allows the extraction of signals of frequency bands different in different schemes.

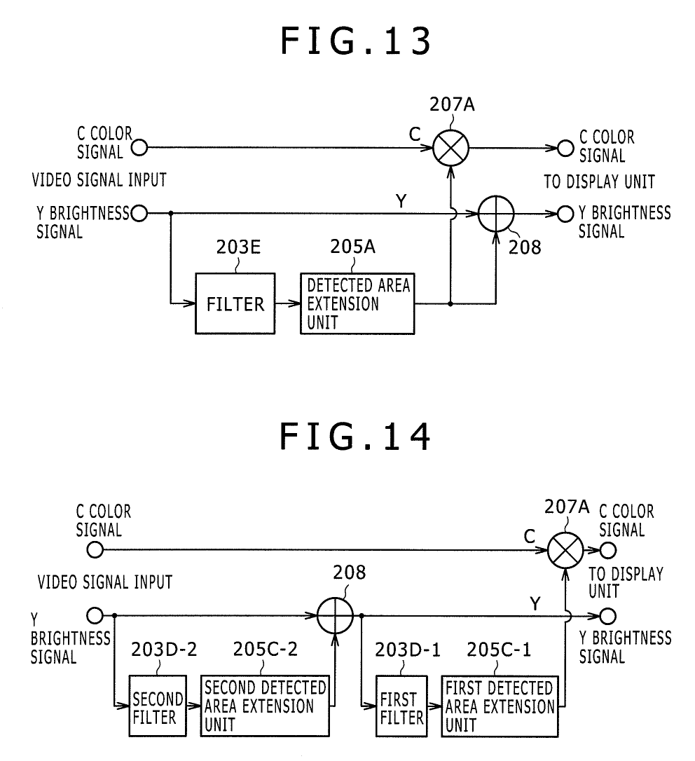

A display signal processing unit 28 shown in FIG. 13 is configured such that both a detection signal to be multiplied by chrominance signal C of the video line and a detection signal to be added to luminance signal Y of the video line are generated by a filter 203E and a detected area extension unit 205A. The signal extracted by the filter 203E and processed by the detected area extension unit 205A is multiplied by chrominance signal C of the video line through a multiplier 207A and added to luminance signal Y of the video line through an adder 208. Thus, one edge-enhanced signal may be added to both luminance signal Y and chrominance signal C.

A display signal processing unit 28 shown in FIG. 14 has a configuration in which a detection signal for executing enhanced display based on the color inherent to the subject is generated from luminance signal Y of the video line with the peaking processing performed by the second filter 203D-2 and the second detected area extension unit 205C-2. To be more specific, a detection signal extracted by the second filter 203D-2 and expanded by the second detected area extension unit 205C-2 is added to luminance signal Y of the video line by the adder 208. Then, luminance signal Y with the detection signal added is entered in the first filter 203D-1.

The signal entered in the first filter 203D-1 is extracted in only a predetermined frequency band by the first filter 203D-1 and the resultant extracted signal is supplied to the first detected area extension unit 205C-1. The signal supplied to the first detected area extension unit 205C-1 is expanded by the first filter 203D-1 to be multiplied by chrominance signal C of the video line through the multiplier 207A. Thus, the above-mentioned configuration may be provided in which the detection signal generated from luminance signal Y on which the peaking has been executed is multiplied by chrominance signal C of the video line.

### 6. Variation 5

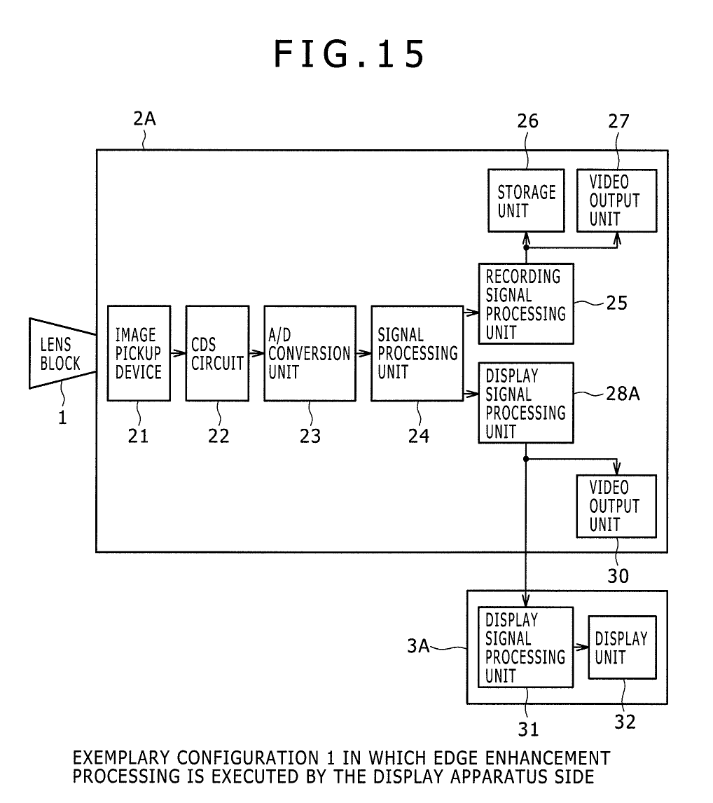

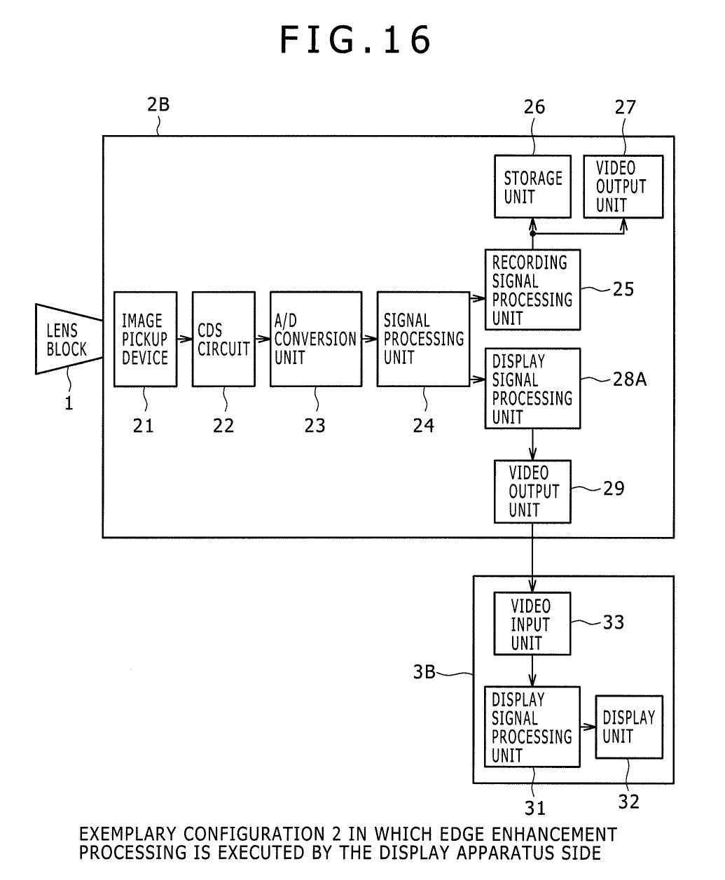

It should be noted that, in the above-mentioned embodiments, the video signal processing apparatus according to the present invention is applied to the image pickup apparatus 100 in which the display unit 29 is incorporated; however, the present invention is not limited to these embodiments. It is also practicable to attach a display apparatus 3A as shown in FIG. 15 to the image pickup apparatus 100 or an external display apparatus 3B as shown in FIG. 16 to the image pickup apparatus 100 through a connector or the like.

With reference to FIG. 15 and FIG. 16, components similar to those previously described with reference to FIG. 1 are denoted by the same reference numerals and detail description thereof is skipped. A camera block 2A shown in FIG. 15 is attached with the display apparatus 3A that is removable relative to the image pickup apparatus 100.

In the configuration shown in FIG. 15, the configuration of the display signal processing unit 28 as shown in FIG. 2 and so on is arranged inside a display signal processing unit 31 in the display apparatus 3A. To be more specific, a display signal processing unit 28A in the camera block 2A executes general processing, such as encode processing and the processing of converting video signals into analog signals, and the display signal processing unit 31 in the display apparatus 3A executes the processing for edge-enhancement display. The video signal edge-enhanced in the display signal processing unit 31 is outputted to the display unit 32 to be displayed as an image.

The image pickup apparatus 100 shown in FIG. 16 is connected with a display apparatus 3B via a cable (not shown) connected to the external interface unit 30. The display apparatus 3B is configured by a video input unit 33, a display signal processing unit 31, and a display unit 32, in which the display signal processing unit 31 executes edge-enhancement processing.

Alternatively, the present invention may be also applied to a configuration in which and lens block 1 and the image pickup device 21 are not arranged and a video signal supplied from an external image pickup apparatus is edge-enhanced to be supplied to the internal display unit 29 or the external display unit 3.

The present application contains subject matter related to that disclosed in Japanese Priority Patent Application JP 2008-239904 filed in the Japan Patent Office on Sep. 18, 2008, the entire content of which is hereby incorporated by reference.

While preferred embodiments of the present invention have been described using specific terms, such description is for illustrative purpose only, and it is to be understood that changes and variations may be made without departing from the spirit or scope of the following claims.

What is claimed is:

1. A video signal processing apparatus comprising:
a level detection unit configured to detect a level of a high-frequency component extracted from an input video signal to determine whether or not said detected level is in excess of a preset predetermined threshold value; and
a signal output unit configured to output, as a color video signal, an input video signal in a section in which the level of said high-frequency component has been determined by said level detection unit to be in excess of said predetermined threshold value and, as a monochromatic video signal, an input video signal in a section in which the level of said high-frequency component has been determined to be lower than said predetermined threshold value.

2. The video signal processing apparatus according to claim 1, further comprising:
a detected area extension unit configured, if the level of said high-frequency component has been determined by said level detection unit to be in excess of said predetermined threshold value, expand the width of a section in which the level is in excess of said predetermined threshold value.

3. The video signal processing apparatus according to claim 2, wherein a predetermined width to be expanded by said detected area expansion unit is variable by a predetermined operation.

4. The video signal processing apparatus according to claim 3, wherein said signal output unit amplifies a level of said color video signal in accordance with a magnitude of said high-frequency component extracted by a filter and outputs the amplified color video signal.

5. The video signal processing apparatus according to claim 4, further comprising:
a monochromatization unit configured to convert said input video signal into a monochromatic video signal,
said signal output unit being a selector that switches between said input video signal as said color video signal and a monochromatic video signal generated by said monochromatization unit depending upon whether or not a signal is entered from said detected area expansion unit and outputs the selected signal.

6. The video signal processing apparatus according to claim 5, further comprising:
a filter configured to extract only a component from said input video signal and output the extracted high-frequency component to said level detection unit,
said signal output unit outputting, as said color video signal, said input video signal while a signal indicative that the level of said high-frequency component is in excess of said predetermined threshold value is entered from said detected area expansion unit and outputting said monochromatic video signal generated by said monochromatization unit while a signal indicative that the level of said high-frequency component is lower than the level of said predetermined threshold value is entered from said detected area expansion unit.

7. The video signal processing apparatus according to claim 5, further comprising:
a filter configured to extract a component with a high-frequency component removed from said input video signal and output said extracted component to said level detection unit,
said signal output unit outputting a monochromatic video signal generated by said monochromatization unit while a signal indicative that the level of said high-frequency component is lower than said predetermined threshold value is entered from said detected area expansion unit and outputting said input video signal as a color video signal while a signal indicative that the level of said high-frequency component is in excess of said predetermined threshold value is entered from said detected area expansion unit.

8. The video signal processing apparatus according to claim 5, where said filter extracts a high-frequency component from said monochromatic video signal generated by said monochromatization unit.

9. The video signal processing apparatus according to claim 5, wherein said signal output unit is a multiplier that multiplies an output signal from said detected area expansion unit by a chrominance signal constituting said input video signal.

10. The video signal processing apparatus according to claim 5, wherein said signal output unit is made up of a multiplier for multiplying an output signal from said detected area expansion unit by a chrominance signal constituting said input video signal and an adder for adding an output signal from said detected area expansion unit to a luminance signal constituting said input video signal.

11. The video signal processing apparatus according to claim 5, wherein
a luminance signal constituting said input video signal is entered in said filter,
said detected area expansion unit is made up of a first detected area expansion unit and a second detected area expansion unit, and
said signal output unit is made up of a multiplier for multiplying said luminance signal constituting said input video signal by an output signal from said first detected area expansion unit and an adder for adding an output signal from said second detected area expansion unit for a chrominance signal constituting said input video signal.

12. The video signal processing apparatus according to claim 11, wherein said filter is made up of a first filter for extracting a signal of a predetermined frequency component from said luminance signal constituting said input video signal and outputting the extracted signal to said first detected area expansion unit and a second filter for extracting a signal of a predetermined frequency component from said chrominance signal constituting said input video signal and outputting the extracted signal to said second detected area expansion unit.

13. The video signal processing apparatus according to claim 11, wherein said luminance signal added with the signal extracted by said second filter and expanded by said second detected area expansion unit is entered in said first filter and said first detected area expansion unit outputs the signal outputted from said first filter to said multiplier.

14. An image pickup apparatus comprising:
an image pickup unit configured to photoelectrically convert a subject light into a video signal;
a level detection unit configured to detect a level of a high-frequency component extracted from said video signal generated by said image pickup unit to determine whether or not said detected level is in excess of a preset predetermined threshold value; and
a signal output unit configured to output, as a color video signal, an input video signal in a section in which the level of said high-frequency component is determined by said level detection unit to be in excess of said predetermined threshold value and, as a monochromatic signal, an input video signal in a section in which the level of said high-frequency component is determined to be lower than said predetermined threshold value.

15. A display apparatus comprising:
a level detection unit configured to detect a level of a high-frequency component extracted from an input video signal to determine whether or not the detected level is in excess of a preset predetermined threshold value;
a signal output unit configured to output, as a color video signal, an input video signal in a section in which the level of said high-frequency component is determined by said level detection unit to be in excess of said predetermined threshold value and, as a monochromatic signal, an input video signal in a section in which the level of said high-frequency component is determined to be lower than said predetermined threshold value; and
a display unit configured to display the video signal outputted from said signal output unit.

16. A video signal processing method comprising the steps of:
detecting a level of a high-frequency component extracted from an input video signal to determine whether or not said detected level is in excess of a preset predetermined threshold value; and
outputting, as a color video signal, an input video signal in a section in which the level of said high-frequency component has been determined in said level detection step to be in excess of said predetermined threshold value and, as a monochromatic video signal, an input video signal in a section in which the level of said high-frequency component has been determined to be lower than said predetermined threshold value.

17. A video signal processing apparatus comprising:
level detection means for detecting a level of a high-frequency component extracted from an input video signal to determine whether or not said detected level is in excess of a preset predetermined threshold value; and
signal output means for outputting, as a color video signal, an input video signal in a section in which the level of said high-frequency component has been determined by said level detection means to be in excess of said predetermined threshold value and, as a monochromatic video signal, an input video signal in a section in which the level of said high-frequency component has been determined to be lower than said predetermined threshold value.

18. An image pickup apparatus comprising:
image pickup means for photoelectrically convert a subject light into a video signal;
level detection means for detecting a level of a high-frequency component extracted from said video signal generated by said image pickup means to determine whether or not said detected level is in excess of a preset predetermined threshold value; and
signal output means for outputting, as a color video signal, an input video signal in a section in which the level of said high-frequency component is determined by said level detection means to be in excess of said predetermined threshold value and, as a monochromatic signal, an input video signal in a section in which the level of said high-frequency component is determined to be lower than said predetermined threshold value.

19. A display apparatus comprising:
level detection means for detecting a level of a high-frequency component extracted from an input video signal to determine whether or not the detected level is in excess of a preset predetermined threshold value;
signal output means for outputting, as a color video signal, an input video signal in a section in which the level of said high-frequency component is determined by said level detection means to be in excess of said predetermined threshold value and, as a monochromatic signal, an input video signal in a section in which the level of said high-frequency component is determined to be lower than said predetermined threshold value; and
display means for displaying the video signal outputted from said signal output means.
